(19) United States
(12) Patent Application Publication
(10) Pub. No.: US 2023/0016032 A1
(43) Pub. Date: Jan. 19, 2023

(54) SYSTEM FOR BLOCKCHAIN-BASED VIRTUAL CURRENCY MEDIATION AND DISTRIBUTION, ACCORDING TO POINT RETURN

(71) Applicant: FSD CO., LTD., Seoul (KR)

(72) Inventor: Seung Hoo LEE, Siheung-si Gyeonggi-do (KR)

(21) Appl. No.: 17/782,055

(22) PCT Filed: Mar. 22, 2021
(86) PCT No.: PCT/KR2021/003503

§ 371 Date: Jun. 2, 2022

(30) Foreign Application Priority Data
Mar. 23, 2020 (KR) 10-2020-0034813

(51) Int. Cl. G06Q 20/06; G06Q 20/38; G06Q 30/02

(52) U.S. Cl. CPC G06Q 20/0655; G06Q 20/382; G06Q 30/0239; G06Q 30/0226

(57) ABSTRACT

Proposed is a blockchain-based virtual currency intermediation and distribution system according to a point return, which can calculate, at a set rate, the amount of return for points that are given or paid offline or online for a user's product purchase or service use, and either convert the calculated amount of point return into a cash currency stepwisely, or convert the calculated amount of point return into a virtual currency recordable on a blockchain according to accumulated points, thereby securing stability and complementarity to support virtual currency transactions.

### TECHNICAL FIELD

The present invention relates to a blockchain-based virtual currency intermediation and distribution system using point return, and more particularly to a blockchain-based virtual currency intermediation and distribution system using point return, which can calculate, at a set rate, the amount of return for points that are given or paid offline or online according to a user's product purchase or service use, and either convert the calculated amount of point return into a cash currency stepwisely or convert the calculated amount of point return into a virtual currency recordable on a blockchain (hereinafter also referred to as “blockchain virtual currency”) according to accumulated points, thereby securing stability and complementarity to support virtual currency transactions.

### BACKGROUND ART

Along with the rapid development of information and communication technologies, the Internet has become a powerful medium for pursuing new economic values and changing the paradigm of life. In addition, the Internet is basically a tool for communication beyond time and space, and it also enables to share a space for business as well as the real transaction market.

Information sharing and product transactions through mobile terminals are being actively performed using wireless communication technologies, and efforts are being made to provide better services and various contents and strengthen marketing strategies to create profits based on the wired and wireless Internet.

In addition, although small business associations, salesmen, and sales companies advertise or promote their products through various means for promotion and sales, the reality is that such advertisement or promotion is insufficient depending on the situation. Further, for open market sales, individuals or small businesses promote their own services using leaflets, but the reality is that the promotion effect is insufficient compared to the cost of producing and distributing promotional materials.

E-commerce services are spreading along with the development of IT technologies and network technologies such as the Internet. E-commerce business model can generally be classified into the following categories: business-to-business (B2B), business-to-customer (B2C), customer-to-customer (C2C), and business-to-government (B2G), which may include a series of activities such as purchase, delivery and marketing of products, and provision of services, as well as transfer or money through a wired or wireless network system.

Meanwhile, in relation to e-commerce, a payment or settlement method using a virtual electronic currency has recently drawn an attention. A typical electronic currency is exemplified by Bitcoin. Virtual electronic currency transactions are performed based on a blockchain data storage technique.

Various items of digital information are recorded on the blockchain and multiple blocks constituting a blockchain ledger are linked to each other in a chain form so that a plurality of nodes can share the origin of information, and the information stored using a blockchain technology can be verified on its own.

Blockchain can exist in various forms depending on its characteristics. When blockchains are configured to be interoperable therebetween, they can perform an intermediary function like an intermediary agency and convert various types of assets on the blockchain to fit its purpose to buy and sell the assets. In addition, when a block is formed like a market creator, a virtual currency of the blockchain itself can be created as a reward.

However, the conventional virtual currency buying and selling method according to the prior art entails a problem in that since differential transaction fees are incurred depending on the characteristics of each virtual currency exchange, a virtual currency buyer suffers from an inconvenience of having to pay unreasonable fees.

Additionally, in the case of a general portal or sales site, a closed customer management system is operated in which a customer registers as a member by inputting his/her personal information and a customer management service is offered to him or her through the member registration. The service is provided to the customer through a procedure of allowing the customer to confirm necessary information and a product providing site, and to compare estimates in order to purchase specific services and products.

Therefore, there is a need for a method of converting points created in shopping malls for selling and marketing products into a virtual currency in use, and converting them into a virtual currency at an exchange so that the virtual currency that can be created and recharged can be combined with finance.

### DISCLOSURE OF INVENTION

### Technical Problem

Accordingly, the present invention has been made in order to solve the above-described problems occurring in the prior art, and it is an object of the present invention is to provide a blockchain-based virtual currency intermediation and distribution system using point return, which can calculate, at a set rate, the amount of return for points that are given or paid offline or online according to a user's product purchase or service use, and either convert the calculated amount of point return into a cash currency stepwisely or convert the calculated amount of point return into a virtual currency recordable on a blockchain according to accumulated points, thereby securing stability and complementarity to support virtual currency transactions.

Technical Solution

To achieve the above objects, a blockchain-based virtual currency intermediation and distribution system using point return according to an embodiment of the present invention include: one or more user terminals configured to take into consideration, at a set rate, the amount of return for points that are given or paid for a purchase of a specific product and a payment for the purchase of the product or that are accumulated as a reward for performing interactive advertisements through SNS and blogs based on the advertisement information provided, and configured to request the amount of point return to be converted into either a cash currency or a virtual currency recordable on a blockchain allocated according to points accumulated through the execution of a drive application; an operation server configured to receive a unit price and a purchase amount of the product from the user terminals, calculate the purchase amount for each user terminal, transmit the points allocated according to the purchase of the product to the user collectively or dividedly, provide the drive application to the user terminal to check whether or not the user terminal performs the interactive advertisements through SNS and blogs of the user terminal based on the advertisement information provided from an advertiser server, provide a corresponding point as a reward for performing the interaction advertisements to the user terminal, calculate a cash currency conversion amount for the accumulated points, and transmits, to the user terminal, the calculated virtual currency conversion amount to be transmitted in response to the request for the blockchain virtual currency conversion; a DB server configured to receive information on the purchase amount of the product of the user terminal and the receipt of the points requested to be given from the operation server in real time, store information on the payment of the points, calculate the point information based on the received purchase amount, and store cash currency and virtual currency payment reference information based on cash currency conversion information and blockchain virtual currency conversion requirement reference information according to the points; the intermediary server configured to transmit a private key to the user terminal in response to a request for conversion and additional purchase or sale of the virtual currency with respect to the calculated virtual currency conversion amount for the points in cooperation with the operation server, and perform a payment agency service by connecting to a virtual currency exchange so that a payment for the actual virtual currency purchase can be made based on the cash currency converted for the points and the virtual currency amount calculated in response to the request for the blockchain virtual currency conversion; an advertiser terminal configured to serve as an object that pays a compensation according to the point as a reward for performing the interactive advertisements online, and provide a title, a description, a search tag, a category, a compensation amount, and target-type information on a description image of the advertisement, and pay a compensation set according to the user's performing the interactive advertisements; and an advertisement server configured to receive and register a title, a description, a search tag, a category, a compensation amount, and a description image of an advertisement that an advertiser of the advertiser terminal wants to promote, expose them in the order of the registration dates and ratings, allow for a search using the category and the search tag to perform user management, compensation deposit, performance inspection, and evaluation management, and spend advertising expenses according to the user's performing the interaction advertisements through SNS and blogs of the user terminal.

### Advantageous Effects

The blockchain-based virtual currency intermediation and distribution system using point return according to an embodiment of the present invention has an effect in that it registers information to promote advertisements of an advertiser, performs the advertisements using the registered information, generates a visitor code through a user's store visit, verification, and duplicate use prevention using offline and online channels, converts points to be provided according to the advertisements into a cash currency stepwisely through a visitor code verification function, and checking the prevention of duplicate use to convert the points into a virtual currency recordable on a blockchain, according to accumulated points, thereby avoiding incurrence of unreasonable advertising expenses of the advertiser.

In addition, the blockchain-based virtual currency intermediation and distribution system using point return according to an embodiment of the present invention has an effect in that it can calculate, at a set rate, the amount of return for points that are given or paid offline or online according to a user's product purchase or service use, and either convert the calculated amount of point return into a cash currency stepwisely or convert the calculated amount of point return into a virtual currency recordable on a blockchain according to accumulated points, thereby securing stability and complementarity to support virtual currency transactions.

### BRIEF DESCRIPTION OF THE DRAWINGS

FIG. 1 is a block diagram showing an entire configuration of a blockchain-based virtual currency intermediation and distribution system using point return according to the present invention.

FIG. 2 is a block diagram showing a detailed configuration of a user terminal of a blockchain-based virtual currency intermediation and distribution system using point return according to the present invention.

FIG. 3 is a block diagram showing a detailed configuration of an operation server of a blockchain-based virtual currency intermediation and distribution system using point return according to the present invention.

FIG. 4 is a block diagram showing a detailed configuration of an intermediary server of a blockchain-based virtual currency intermediation and distribution system using point return according to the present invention.

### BEST MODE FOR CARRYING OUT THE INVENTION

Hereinafter, preferred embodiments of according to the present invention will be described in detail with reference to the accompanying drawings in order for a person of ordinary skill in the art to sufficiently understand and carry out the present invention. In the following description of the present invention, a detailed description of related known functions and configurations incorporated herein will be omitted, if necessary, when it may rather make the subject matter of the present invention unclear.

The present invention provides a blockchain-based virtual currency intermediation and distribution system using point return, in which points are paid to a user at a rate allocated and set through product purchase, service use, and advertisement promotion, and a corresponding point are converted into a cash currency or a virtual currency that can be recorded on a blockchain, thereby securing the use and distribution of the cash currency or the virtual currency to support virtual currency transactions.

The characteristics of the blockchain according to the present invention will be described below. The blockchain refers to a digital ledger that records and stores a history of virtual currency transactions and is used as a technology for preventing hacking in online transactions that require credit, which is also used as a security technology for various cryptocurrencies including Bitcoin. In other words, the blockchain is a digitally distributed public ledger that records and stores the history of virtual currency transactions.

In other words, the blockchain employs a peer-to-peer (P2P) network as one of the distributed databases, which is why the blockchain can be stored in computers of all Bitcoin users. Originally, the Bitcoin is an electronic currency used online using a security technology for Bitcoin transactions, and anyone can issue or use it without a separate Bitcoin issuer or management agency. The Bitcoin adopts a public key encryption technique that allows only a user with a specific private key to check information, but there is little or no fee since it enables to make direct transactions between the parties concerned without going through a bank or a currency exchange.

The blockchain also called the distributed database is a technology that physically distributes data so that multiple users (or nodes) share a large-scale database. The distributed database distributes data therein, since it is less expensive and efficient against failures.

Therefore, the blockchain creates a P2P network of virtual currency users connected through the Internet, and a virtual currency transaction history (block) is stored in the users' computers through the P2P network. Among the virtual currency transaction history, a transaction history that matches the data of the majority of users is identified as a normal ledger and stored in blocks. The security stability of the blockchain increases as more users share data. The blockchain is being utilized for various online services such as cloud computing services besides the Bitcoin.

When a virtual currency transaction is executed, a specific account for transaction of a virtual currency is called an ‘electronic wallet (e-wallet)’. Such an electronic wallet includes at least one transaction account. Each e-wallet is assigned a unique number of about 30 characters, which is a combination of Arabic numerals, and lowercase letters and uppercase letters of the Roman alphabet, so that transactions are performed based on the public key encryption technique.

Thus, a virtual currency can create an account in a place where an e-wallet can be used, such as a smartphone or a personal computer. When the account is created, a pair of encryption keys is generated on the Internet. One of the encryption keys is a private key that can be identified by only a user himself/herself through a user terminal, and the other one is an encryption key that is open to everyone who uses a virtual account.

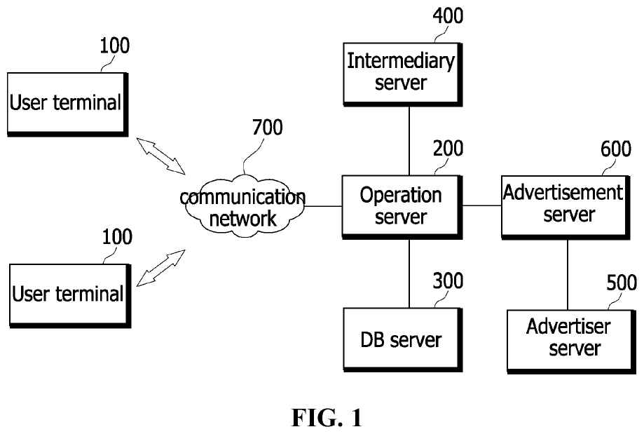

FIG. 1 is a block diagram showing an entire configuration of a blockchain-based virtual currency intermediation and distribution system using point return according to an embodiment of the present invention. The blockchain-based virtual currency intermediation and distribution system includes a user terminal 100, an operation server 200, a DB server 300, an intermediary server 400, an advertiser terminal 500, an advertisement server 600, and a communication network 700.

The detailed operation of each constituent elements of the blockchain-based virtual currency intermediation and distribution system using point return will be described hereinafter with reference to FIG. 1. First, the user terminal 100 takes into consideration, at a set rate, the amount of return for points that are given or paid for a purchase of a specific product and a payment for the purchase of the product or that are accumulated as a reward for performing interactive advertisements through SNS and blogs based on the advertisement information provided, and requests the amount of point return to be converted into either a cash currency or a virtual currency recordable on a blockchain allocated according to points accumulated through the execution of a drive application (app).

In other words, the user terminal 100 may request that the amount of return for the points provided according to purchase and advertisement activities thereof be converted into a cash currency or a virtual currency recordable on the blockchain by executing the driving application (app) provided thereto from the operation server 200. In addition, the user terminal 100 may receive a service according to the intermediation and distribution of the virtual currency through the intermediary server 400 operated in cooperation with the operation server 200 in order to purchase an additional virtual currency.

In the meantime, the user terminal 100 may be a smartphone, a personal computer (PC), a tablet mobile communication device, a wearable device, a smart assistant, or the like. The user terminal 100 supports a user to execute the drive application (app) to purchase products, promote advertisements, request the conversion of the points into the virtual currency, request the additional purchase or sale of the virtual currency, and confirm processing results through an internal application program.

The operation server 200 receives a unit price and a purchase amount of the product from the user terminals 100, calculates the purchase amount for each user terminal 100, transmits the points allocated according to the purchase of the product to the user terminal 100 collectively or dividedly, provides the drive application to the user terminal to check whether or not the user terminal performs the interactive advertisements through SNS and blogs of the user terminal based on the advertisement information provided from the advertiser server, provides a corresponding point as a reward for performing the interaction advertisements to the user terminal 100, calculates a cash currency conversion amount for the accumulated points, or transmits, to the user terminal 100, the calculated virtual currency conversion amount to be transmitted to the internal server 400 in response to the request for the blockchain virtual currency conversion.

In other words, the operation server 200 controls the overall operation for the conversion of the points given for the activities of the user terminal 100 into the cash currency, receives the advertisement information from the advertiser terminal 500 to transmit corresponding advertisement information to the user terminal 100 through the driving application (app), receives and stores the points to be given for the advertisement activities of the user terminal 100 through the advertisement server 600 and enables to convert corresponding points into a cash currency or a virtual currency.

In addition, the operation server 200 is operated to execute the payment for the purchase of the virtual currency in cooperation with the intermediary server 400 in response to a request for the conversion of the points into the virtual currency and the purchase of the additional virtual currency by the user terminal 100 through the drive application (app).

The DB server 300 receives information on the purchase (monetary) amount of the product of the user terminal 100 and the receipt of the points requested to be given from the operation server 200 in real time, stores information on the payment of the points, calculates the point information based on the received purchase amount, and stores cash currency and virtual currency payment reference information based on cash currency conversion information and blockchain virtual currency conversion requirement reference information according to the points.

The intermediary server 400 transmits a private key to the user terminal 100 in response to a request for conversion and additional purchase or sale of the virtual currency with respect to the calculated virtual currency conversion amount for the points in cooperation with the operation server 200, and performs a payment agency service by connecting to a virtual currency exchange so that a payment for the actual virtual currency purchase can be made based on the cash currency converted for the points through the private key and the virtual currency amount calculated in response to the request for the blockchain virtual currency conversion.

In addition, the advertiser terminal 500 serves as an object that pays a compensation according to the point as a reward for performing the interactive advertisements online. The advertiser terminal 500 provides a title, a description, a search tag, a category, a compensation amount, a recruitment number, a recruitment condition, a completion condition, a recruitment deadline, a mission deadline, and target-type information on a description image of the advertisement, and pays a compensation set according to the user's performing the interactive advertisements.

The advertisement server 600 is connected to the advertiser terminal 400, and receives and registers a title, a description, a search tag, a category, a compensation amount, and a description image of an advertisement that an advertiser of the advertiser terminal 400 wants to promote, exposes them in the order of the registration dates and ratings, allows for a search using the category and the search tag to performs user management, compensation deposit, performance inspection, and evaluation management, and spends advertising expenses according to the user's performing the interaction advertisements through SNS and blogs of the user terminal 100.

The communication network 700 provides a communication medium of allowing the advertisement information of the advertiser terminal 500 to be displayed on the user terminal 100 therethrough or to be registered on SNS and blogs according to the advertisement activities of the user terminal 10, or performs a cooperative operation among the operation server 200, and advertiser terminal 500, and the user terminal 100 in order to pay points according to the purchase of the product, perform the interactive advertisements, and convert the points into a virtual currency through the intermediary server 400. The communication network 700 is a large-scale high-speed backbone communication network enabling a private networking service and a high capacity, long-distance voice or data service, and may be either the Internet or a next-generation wired and wireless network for providing a high-speed multimedia service. When the communication network 700 is a mobile communication network, it may be a synchronous mobile communication network or an asynchronous mobile communication network.

The asynchronous mobile communication network may be exemplified by a wideband code division multiple access (WCDMA) communication network. In this case, although not shown in the drawing, a radio network controller (RNC) may be included in the communication network 700. Meanwhile, although the WCDMA network are given as an example of the asynchronous mobile communication network, the asynchronous mobile communication network may be the next-generation communication networks such as a 3G LTE network, a 4G networks, a 5G networks, or an IP network based on other IPs. The communication network 700 is operated in cooperation with the user terminal 100, the operation server 200, the DB server 300, the intermediary server 400, the advertiser terminal 500, and the advertisement server 600 to transmit and receive signals and data therebetween.

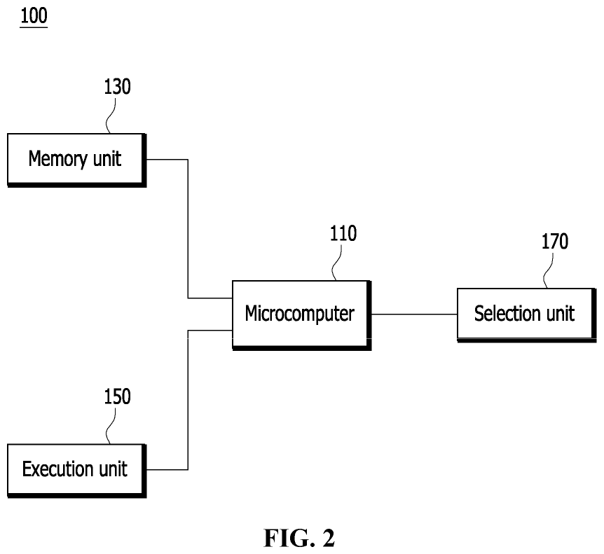

FIG. 2 is a block diagram showing a detailed configuration of the user terminal 100 of a blockchain-based virtual currency intermediation and distribution system using point return according to the present invention. The user terminal 100 for intermediation and distribution of a virtual currency includes a microcomputer 110, a memory unit 130), an execution unit 150, and a selection unit 170. The detailed configuration of the user terminal 200 will be described hereinafter with reference to FIGS. 1 and 2. First, the microcomputer 110 controls the overall operation of the user terminal 100 in order to take into consideration, at a set rate, the amount of return for the points that are given for the purchase of a specific product and the payment for the purchase of the product or that are accumulated as a reward for performing interactive advertisements through SNS and blogs based on the advertisement information provided, and request the amount of point return to be converted into either the cash currency or the virtual currency recordable on the blockchain allocated according to points accumulated through the execution of the drive application (app).

The memory unit 130 stores the points that are given for the purchase of the product and the payment for the purchase of the product and the points that are accumulated as a reward for performing the interactive advertisements through SNS and blogs based on the advertisement information of the advertiser server, or receives a private key from the intermediary server 400 through the communication network 700 to store a corresponding key for the purpose of converting the accumulated points into a virtual currency recordable on the blockchain and performing a virtual currency transaction including the additional purchase or sale of the virtual currency, in response to a control signal from the microcomputer 110.

In addition, the memory unit 130 may receive the purchase amount of the product and the points requested to be given from the DB server 300 in real time through the drive of the execution unit 150 to store the given points, or may store cash currency conversion information and blockchain virtual currency conversion reference information based on the point information transmitted according to the purchase amount of the product and store virtual currency conversion quotation information according to the accumulated and calculated points.

In the meantime, the memory unit 130 is performed in operation based on an encryption method through a private key stored for the virtual currency transaction, and stores and carries the encryption key as one private key for identification of a user himself/herself for each user terminal using the encryption key.

The execution unit 150 executes the drive application (app) for the accumulation of the points, and the purchase and conversion of the virtual currency, which is provided by the operation server 200 according to the control signal of the microcomputer 110 in response to the control signal from the microcomputer 110, allows a user of the user terminal 100 to perform the purchase of the specific product, the payment for the purchase of the product, and the interactive advertisements through SNS and blogs based on the advertisement information of the advertiser server or use the accumulated points stored in the memory unit, or transmits execution information on whether to convert the points into the currency recordable on the blockchain and additionally purchase the virtual currency through the private key provided from the intermediary server 400 through the operation server 200 at an additional cost.

The selection unit 170 designates a corresponding drive application (app) provided from the operation server 200 through the execution unit 150 in response to the control signal from the microcomputer 110 to allow the corresponding drive application (app) to be executed, designates either a corresponding selection signal to convert the pointers given for the purchase of the product into the cash currency or a corresponding icon to execute SNS and blogs based on the advertisement information of the advertiser server, and designates a corresponding selection signal for the additional purchase of the virtual currency of the blockchain or the sale of the converted virtual currency through the intermediary server 400 based on the points accumulated and stored in the memory unit 130.

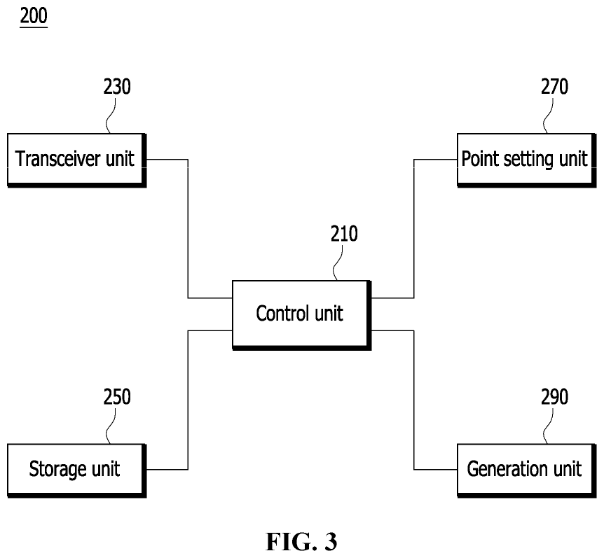

FIG. 3 is a block diagram showing a detailed configuration of the operation server 200 of a blockchain-based virtual currency intermediation and distribution system using point return according to the present invention. The operation server 200 of the present invention includes a control unit 210, a transceiver unit 230, a storage unit 250, a point setting unit 270, and a generation unit 290. The function and operation of the user terminal 200 will be described hereinafter with reference to FIGS. 1 to 3.

The control unit 210 controls the overall operation of the operation server 200 in order to receive a unit price and a purchase amount of the product from the user terminals 100, calculate the purchase amount for each user terminal 100, transmit the points allocated according to the purchase of the product to the user terminal 100 collectively or dividedly, provide the drive application (app) to the user terminal to check whether or not the user terminal performs the interactive advertisements through SNS and blogs of the user terminal based on the advertisement information provided from the advertiser server, provide a corresponding point as a reward for performing the interaction advertisements to the user terminal 100, calculate a cash currency conversion amount for the accumulated points, and transmit and display, to the user terminal 100, the calculated virtual currency conversion amount to be transmitted to the intermediary server 400 in response to the request for the blockchain virtual currency conversion.

In addition, the control unit 210 controls the operation of the operation server 200 that receives the advertisement information from the advertiser terminal 500 to transmit corresponding advertisement information to the user terminal 100 through the driving application (app), receives and stores the points to be given for the advertisement activities of the user terminal 100 through the advertisement server 600 and enables to convert corresponding points into a cash currency or a virtual currency.

Further, the transceiver unit 230 transmits the drive application (app) for performing the interactive advertisements and the blockchain-based transactions to the user terminal 100 to allow the drive application to be displayed on the user terminal in response to a control signal from the control unit 210; or receives a result of performing the interactive advertisements according to the purchase of the product and performance of the advertisements by a user of the user terminal 100 from the user terminal, and transmits points allocated to the storage unit 250 according to the purchase of the product and the performance of the advertisements to the user terminal; or receives information on a request for the conversion of the pointers of the user terminal 100 into a cash currency and a blockchain virtual currency and a request for additional purchase and sale of the virtual currency from the user terminal, transmits a point-converted amount to the user terminal 100, transmits information on the blockchain virtual currency conversion to the intermediary server 400, receives private keys according to the request for the additional purchase and sale of the virtual currency from the intermediary server, and transmits a corresponding private key to the user terminal 100 or transmits state information on the blockchain virtual currency conversion and the purchase and sale of the virtual currency to the intermediary server.

The storage unit 250 receives the advertisement information from the advertiser terminal 500 through the advertisement server 600 in response to the control signal from the control unit 210 and stores corresponding advertisement information therein; or classifies and stores points to be paid for each product, classifies remaining points for each user and for each product with respect to the points to be paid for each product, and stores information on the remaining points according to corresponding point payment.

The point setting unit 270 stores points allocated according to the purchase of the product and points allocated according to interactive advertisement activities based on the advertisement information in response to the control signal of the control unit 210, or classifies and sets point payment amounts for providing points for each sale product and additionally sets an additional point amount according to the purchase of a plurality of products.

The generation unit 290 generates information on the user terminal 100 according to the blockchain virtual currency conversion and the additional purchase and sale of the virtual currency, generates an encryption block according to a transaction history based on the private key information transmitted from the intermediary server 400, and monitors a virtual currency transaction history between the user terminal and the intermediary server 400 in real time to update and generates related information to allow the updated information according to a corresponding transaction to be stored in the storage unit 250.

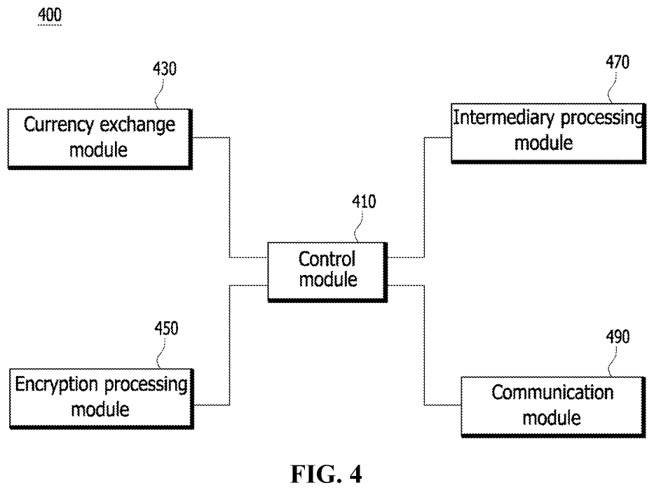

FIG. 4 is a block diagram showing a detailed configuration of the intermediary server 400 of a blockchain-based virtual currency intermediation and distribution system using point return according to the present invention. The intermediary server 400 of the present invention includes a control module 410, a currency exchange module 430, an encryption processing module 450, an intermediary processing module 470, and a communication module 490. The detailed configuration and operation of the user terminal 200 will be described hereinafter with reference to FIGS. 1 to 4. First, the control module 410 controls the overall operation of the intermediary server 400 in order to generate and transmit a private key to the user terminal 100 in response to a request for conversion and additional purchase or sale of the virtual currency by the user terminal 100 with respect to the converted and calculated virtual currency amount for the points in cooperation with the operation server 200, and perform a payment agency service by connecting to a virtual currency exchange so that a payment for the actual virtual currency purchase can be made based on the cash currency converted for the points through the private key and the virtual currency amount calculated in response to the request for the blockchain virtual currency conversion.

In addition, the currency exchange module 430 calculates a monetary amount corresponding to the virtual currency, performs a settlement for the monetary amount in consideration of a preset fee rate, and calculates a currency exchange amount of the virtual currency based on the settlement amount in response to a signal indicative of a request for the conversion and additional purchase or sale of the virtual currency by the user terminal 100 in response to a control signal from the control module 410.

The currency exchange module 430 records information on the additional purchase and sale of the virtual currency through an algorithmized exchange rate table with respect to a transaction history related to the purchase amount of the virtual currency requested by the user of the user terminal 100, and calculates the currency exchange amount of the virtual currency for the purpose of the virtual current intermediation of the present invention. In this case, the current exchange module 430 may calculate a transaction fee in consideration of the preset fee rate, and then transmit the transaction fee to the user terminal 100 through the communication module 490 to provide a transfer service.

Further, the encryption processing module 450 encrypts, using a private key for a virtual account, the settlement monetary amount corresponding to the currency exchange amount of the virtual currency calculated by the currency exchange module 430 in response to a request for the conversion, and additional purchase of the virtual currency by the user terminal 100, and stores an encryption block in response to the control signal from the control module 410.

The intermediary processing module 470 performs a settlement for a payment amount for the purchase or sale of the virtual currency through the private key for the virtual account of the encryption block stored in the encryption processing module 450 at the request of the user terminal 100 in response to the control signal from the control module 410, and perform a payment or deposit transaction of the purchase or sale amount of the virtual currency. Meanwhile, the intermediary processing module 470 generates selling record information such as a request identification code, a selling price, and a selling quantity based on a selling list according to the virtual currency transactions, and corrects corresponding information according to each event.

Besides, the communication module 490 transmits a processing history according to a settled result of the payment amount or the deposit amount for the purchase or sale of the virtual currency to the operation server 200 and the user terminal 100 in response to the control signal of the control module 410.

[The description of reference numeral
of the main elements in drawings]

| | |
|---|---|
| 100: user terminal | |
| 110: microcomputer | 130: memory unit |
| 150: execution unit | 170: selection unit |
| 200: operation server | |
| 210: control unit | 230: transceiver unit |
| 250: storage unit | 270: point setting unit |
| 290: generation unit | |
| 300: DB server | |
| 400: intermediary server | |
| 410: control module | 430: currency exchange module |
| 450: encryption processing module | 470: intermediary processing |
| | module |
| 490: communication module | |
| 500: advertiser terminal | |
| 600: advertisement server | |
| 700: communication network | |

1. A blockchain-based virtual currency intermediation and distribution system using point return, the system comprising:
one or more user terminals (100) configured to take into consideration, at a set rate, the amount of return for points that are given or paid for a purchase of a specific product and a payment for the purchase of the product or that are accumulated as a reward for performing interactive advertisements through SNS and blogs based on the advertisement information provided, and configured to request the amount of point return to be converted into either a cash currency or a virtual currency recordable on a blockchain allocated according to points accumulated through the execution of a drive application;
an operation server (200) configured to receive a unit price and a purchase amount of the product from the user terminals (100), calculate the purchase amount for each user terminal (100), transmit the points allocated according to the purchase of the product to the user terminal (100) collectively or dividedly, provide the drive application (app) to the user terminal to check whether or not the user terminal performs the interactive advertisements through SNS and blogs of the user terminal based on the advertisement information provided from an advertiser server, provide a corresponding point as a reward for performing the interaction advertisements to the user terminal (100), calculate a cash currency conversion amount for the accumulated points, and transmit, to the user terminal (100), the calculated virtual currency conversion amount to be transmitted in response to the request for the blockchain virtual currency conversion;
a DB server (300) configured to receive information on the purchase amount of the product of the user terminal (100) and the receipt of the points requested to be given from the operation server (200) in real time, store information on the payment of the points, calculate the point information based on the received purchase amount, and store cash currency and virtual currency payment reference information based on cash currency conversion information and blockchain virtual currency conversion requirement reference information according to the points;
an intermediary server (400) configured to transmit a private key to the user terminal (100) in response to a request for conversion and additional purchase or sale of the virtual currency with respect to the calculated virtual currency conversion amount for the points in cooperation with the operation server (200), and perform a payment agency service by connecting to a virtual currency exchange so that a payment for the actual virtual currency purchase can be made based on the cash currency converted for the points through the private key and the virtual currency amount calculated in response to the request for the blockchain virtual currency conversion;
an advertiser terminal (500) configured to serve as an object that pays a compensation according to the point as a reward for performing the interactive advertisements online, and provide a title, a description, a search tag, a category, a compensation amount, and target-type information on a description image of the advertisement, and pay a compensation set according to the user's performing the interactive advertisements; and
an advertisement server (600) configured to receive and register a title, a description, a search tag, a category, a compensation amount, and a description image of an advertisement that an advertiser of the advertiser terminal (400) wants to promote, expose them in the order of the registration dates and ratings, allow for a search using the category and the search tag to perform user management, compensation deposit, performance inspection, and evaluation management, and spend advertising expenses according to the user's performing the interaction advertisements through SNS and blogs of the user terminal (100).

2. The blockchain-based virtual currency intermediation and distribution system using point return according to claim 1, wherein each of the user terminals (100) further comprises:
a microcomputer (110) configured to control the overall operation of the user terminal 100 in order to take into consideration, at a set rate, the amount of return for the points that are given for the purchase of a specific product and the payment for the purchase of the product or that are accumulated as a reward for performing interactive advertisements through SNS and blogs based on the advertisement information provided, and request the amount of point return to be converted into either the cash currency or the virtual currency recordable on the blockchain allocated according to points accumulated through the execution of the drive application (app);
a memory unit (130) configured to store the points that are given for the purchase of the product and the payment for the purchase of the product and the points that are accumulated as a reward for performing the interactive advertisements through SNS and blogs based on the advertisement information of the advertiser server, or receives a private key from the intermediary server (400) through a communication network (700) to store a corresponding key for the purpose of converting the accumulated points into a virtual currency recordable on the blockchain and performing a virtual currency transaction including the additional purchase or sale of the virtual currency, in response to a control signal from the microcomputer (110);
an execution unit (150) configured to execute the drive application (app) for the accumulation of the points, and the purchase and conversion of the virtual currency, which is provided by the operation server (200) according to the control signal of the microcomputer (110) in response to the control signal from the microcomputer (110), allow a user of the user terminal (100) to perform the purchase of the specific product, the payment for the purchase of the product, and the interactive advertisements through SNS and blogs based on the advertisement information of the advertiser server or use the accumulated points stored in the memory unit, and transmit execution information on whether to convert the points into the currency recordable on the blockchain and additionally purchase the virtual currency through the private key provided from the intermediary server 400 through the operation server (200) at an additional cost; and
a selection unit (170) configured to designate a corresponding drive application (app) provided from the operation server 200 through the execution unit 150 in response to the control signal from the microcomputer 110 to allow the corresponding drive application (app) to be executed, designate either a corresponding selection signal to convert the pointers given for the purchase of the product into the cash currency or a corresponding icon to execute SNS and blogs based on the advertisement information of the advertiser server, and designate a corresponding selection signal for the additional purchase of the virtual currency of the blockchain or the sale of the converted virtual currency through the intermediary server 400 based on the points accumulated and stored in the memory unit 130.

3. The blockchain-based virtual currency intermediation and distribution system using point return according to claim 1, wherein the operation server (200) further comprises:
a control unit 210 configured to control the overall operation of the operation server 200 in order to receive a unit price and a purchase amount of the product from the user terminals (100), calculates the purchase amount for each user terminal (100), transmit the points allocated according to the purchase of the product to the user terminal (100) collectively or dividedly, provide the drive application to the user terminal to check whether or not the user terminal performs the interactive advertisements through SNS and blogs of the user terminal based on the advertisement information provided from the advertiser server, provide a corresponding point as a reward for performing the interaction advertisements to the user terminal (100), calculate a cash currency conversion amount for the accumulated points, and transmit and display, to the user terminal (100), the calculated virtual currency conversion amount to be transmitted to the intermediary server (400) in response to the request for the blockchain virtual currency conversion;
a transceiver unit (230) configured to transmit the drive application (app) for performing the interactive advertisements and the blockchain-based transactions to the user terminal (100) to allow the drive application to be displayed on the user terminal in response to a control signal from the control unit (210); configured to receive a result of performing the interactive advertisements according to the purchase of the product and performance of the advertisements by a user of the user terminal (100) from the user terminal, and transmit points allocated according to the purchase of the product and the performance of the advertisements to the user terminal; or configured to receive information on a request for the conversion of the pointers of the user terminal 100 into a cash currency and a blockchain virtual currency and a request for additional purchase and sale of the virtual currency from the user terminal, transmit a point-converted amount to the user terminal (100), transmit information on the blockchain virtual currency conversion to the intermediary server (400), receive private keys according to the request for the additional purchase and sale of the virtual currency from the intermediary server, and transmit a corresponding private key to the user terminal (100) or transmit state information on the blockchain virtual currency conversion and the purchase and sale of the virtual currency to the intermediary server;
a storage unit (250) configured to receive the advertisement information from the advertiser terminal (500) through the advertisement server (600) in response to the control signal from the control unit (210) and store corresponding advertisement information therein; or configured to classify and store points to be paid for each product, classify remaining points for each user and for each product with respect to the points to be paid for each product, and store information on the remaining points according to corresponding point payment;
a point setting unit (270) configured to store points allocated according to the purchase of the product and points allocated according to interactive advertisement activities based on the advertisement information in response to the control signal of the control unit (210), or classify and set point payment amounts for providing points for each sale product and additionally set an additional point amount according to the purchase of a plurality of products; and
a generation unit (290) configured to generate information on the user terminal (100) according to the blockchain virtual currency conversion and the additional purchase and sale of the virtual currency in response to the control signal of the control unit (210), generate an encryption block according to a transaction history based on the private key information transmitted from the intermediary server 400, and monitor a virtual currency transaction history between the user terminal and the intermediary server (400) in real time to update and generates related information to allow the updated information according to a corresponding transaction to be stored in the storage unit (250).

4. The blockchain-based virtual currency intermediation and distribution system using point return according to claim 1, wherein the intermediary server (400) comprises:
a control module (410) configured to control the overall operation of the intermediary server (400) in order to generate and transmit a private key to the user terminal (100) in response to a request for conversion and additional purchase or sale of the virtual currency by the user terminal 100 with respect to the converted and calculated virtual currency amount for the points in cooperation with the operation server (200), and perform a payment agency service by connecting to a virtual currency exchange so that a payment for the actual virtual currency purchase can be made based on the cash currency converted for the points through the private key and the virtual currency amount calculated in response to the request for the blockchain virtual currency conversion;
a currency exchange module (430) configured to calculate a monetary amount corresponding to the virtual currency, perform a settlement for the monetary amount in consideration of a preset fee rate, and calculate a currency exchange amount of the virtual currency based on the settlement amount in response to a signal indicative of a request for the conversion and additional purchase or sale of the virtual currency by the user terminal (100) in response to a control signal from the control module (410);
an encryption processing module (450) configured to encrypt, using a private key for a virtual account, the settlement monetary amount corresponding to the currency exchange amount of the virtual currency calculated by the currency exchange module (430) in response to a request for the conversion, and additional purchase of the virtual currency by the user terminal (100), and store an encryption block in response to the control signal from the control module (410).
an intermediary processing module (470) configured to perform a settlement for a payment amount for the purchase or sale of the virtual currency through the private key for the virtual account of the encryption block stored in the encryption processing module (450) at the request of the user terminal (100) in response to the control signal from the control module (410), and perform a payment or deposit transaction of the purchase or sale amount of the virtual currency; and
a communication module (490) configured to transmit a processing history according to a settled result of the payment amount or the deposit amount for the purchase or sale of the virtual currency to the operation server (200) and the user terminal (100) in response to the control signal of the control module (410).
